(19) United States
(12) Patent Application Publication
(10) Pub. No.: US 2015/0244215 A1
(43) Pub. Date: Aug. 27, 2015

(54) PERMANENT MAGNET EMBEDDED TYPE ROTOR OF ELECTRIC ROTATING MACHINE AND ELECTRIC ROTATING MACHINE

(71) Applicant: KABUSHIKI KAISHA TOYOTA JIDOSHOKKI, Kariya-shi (JP)

(72) Inventor: Hiroshi FUKASAKU, Kariya-shi (JP)

(73) Assignee: KABUSHIKI KAISHA TOYOTA JIDOSHOKKI, Kariya-shi (JP)

(21) Appl. No.: 14/628,354

(22) Filed: Feb. 23, 2015

(30) Foreign Application Priority Data
Feb. 27, 2014 (JP) 2014-037276

(51) Int. Cl. H02K 1/27

(52) U.S. Cl. CPC H02K 1/276

(57) ABSTRACT

An outer edge of a first through hole near an outer periphery of a first core plate is closer to a permanent magnet than an outer edge of a second through hole near an outer periphery of a second core plate. Further, a second bridge length is less than a first bridge length.

### BACKGROUND OF THE INVENTION

The present invention relates to a permanent magnet embedded type rotor of an electric rotating machine, and an electric rotating machine.

A rotor core of a permanent magnet embedded type rotor of an electric rotating machine has a plurality of through holes arranged in a peripheral direction of the rotor core. Permanent magnets are housed in the plurality of through holes, respectively. The permanent magnets are arranged so that magnetic poles of the adjacent permanent magnets are different from each other. In this case, a bridge section is formed between the permanent magnets adjacent in the peripheral direction of the rotor core. Each of the bridge sections extends between an outer peripheral edge of the rotor core and an edge of each through hole to the peripheral direction of the rotor core. When magnetic flux short-circuits across the bride sections, the torque drops.

For example, Japanese Patent No. 5359239 discloses that a notch is formed near the bridge section on an outer peripheral edge of a rotor core. Further, Japanese Laid-Open Patent Publication No. 2004-104962 discloses that a permanent magnet is divided into two to be arranged on a rotor core, and an opening is formed near a bridge section of the rotor core. When the notch or the opening is formed on the rotor core, short-circuit of magnetic flux across the bridge sections is suppressed, and thus a reduction in the torque is suppressed.

However, when the notch or the opening is formed on the rotor core as described in Japanese Patent No. 5359239 and Japanese Laid-Open Patent Publication No. 2004-104962, strength of the outer periphery of the rotor core drops. For this reason, when a load is imposed on the outer periphery of the rotor core from the permanent magnets by centrifugal force caused by rotation of the rotor core, the outer periphery of the rotor core might be damaged.

### SUMMARY OF THE INVENTION

It is an object of the present invention to provide a permanent magnet embedded type rotor of an electric rotating machine for enabling strength of an outer periphery of a rotor core to be secured and short-circuit of a magnetic flux across bridge sections to be suppressed, and an electric rotating machine.

In order to solve the above problem, a first aspect of the present invention provides a permanent magnet embedded type rotor of an electric rotating machine. The permanent magnet embedded type rotor includes a rotor core having a plurality of through holes arranged in a peripheral direction of the rotor core, a plurality of permanent magnets that is housed in the plurality of through holes, respectively, and arranged so that magnetic poles of the adjacent permanent magnets are different from each other, and bridge sections that are provided between the permanent magnets that are adjacent in the peripheral direction of the rotor core and that have magnetic poles that are different from each other. Each bridge section extends in the peripheral direction of the rotor core between an outer peripheral edge of the rotor core and edges of the through holes. The rotor core is constituted by laminating a plurality of first core plates and a plurality of second core plates. Each of the first core plates has a first through hole forming the through hole and a first bridge section forming the bridge section. Each of the second core plates has a second through hole forming the through hole and a second bridge section forming the bridge section. An outer edge of the first through hole near an outer periphery of the first core plate is closer to the permanent magnet than an outer edge of the second through hole near an outer periphery of the second core plate. A minimum distance between the outer peripheral edge of the first core plate and an edge of the first through hole is defined as a first bridge length in the first bridge section. A minimum distance between the outer peripheral edge of the second core plate and an edge of the second through hole is defined as a second bridge length in the second bridge section. The second bridge length is less than the first bridge length.

In order to solve the above problem, a second aspect of the present invention provides an electric rotating machine having the permanent magnet embedded type rotor.

### BRIEF DESCRIPTION OF THE DRAWINGS

FIG. 1 is a cross-sectional plan view of an electric rotating machine according to one embodiment of the present invention;

FIG. 2 is a cross-sectional side view illustrating an enlarged vicinity of through holes of a rotor;

FIG. 3A is a cross-sectional plan view illustrating an enlarged vicinity of a first through hole of a first core plate of the rotor; and

FIG. 3B is a cross-sectional plan view illustrating an enlarged vicinity of a second through hole of a second core plate of the rotor.

### DETAILED DESCRIPTION OF THE PREFERRED EMBODIMENTS

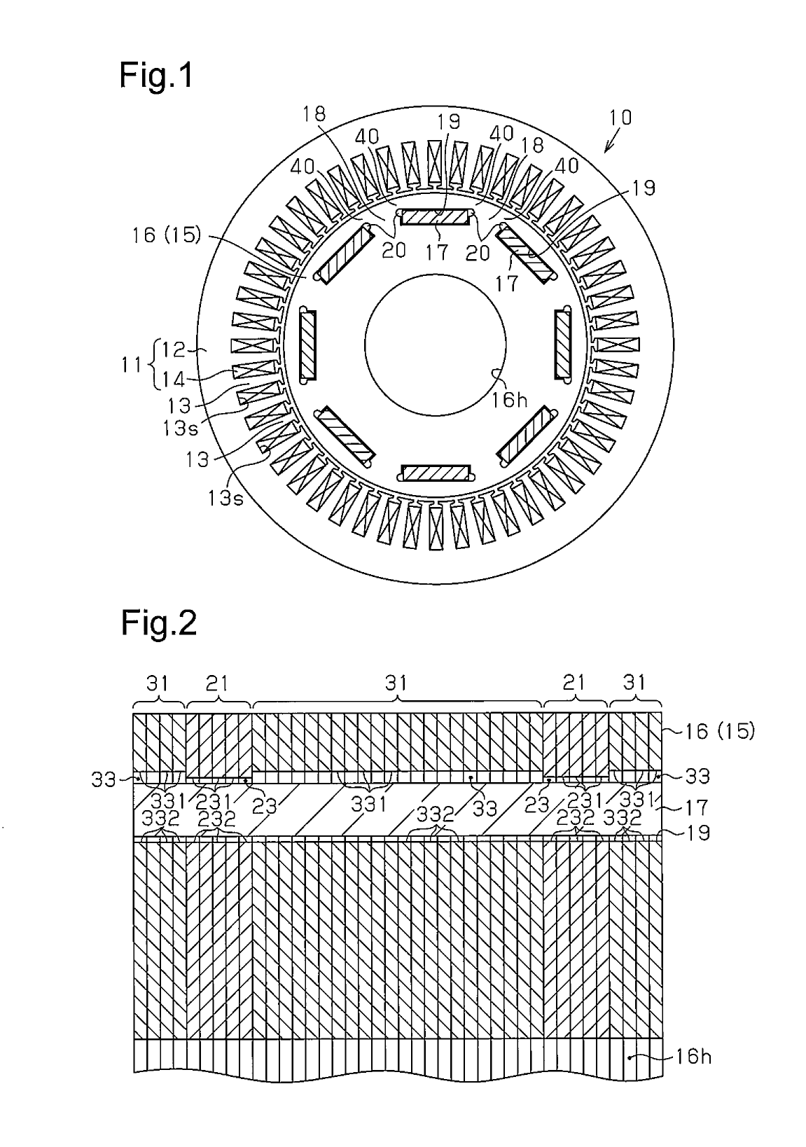

A permanent magnet embedded type rotor of an electric rotating machine (hereinafter, simply “rotor”) of the present invention will be described below as one embodiment of a rotor to be mounted into a vehicle with reference to FIG. 1 to FIG. 3B.

As shown in FIG. 1, a stator 11 composing an electric rotating machine 10 is composed of a circular stator core 12 and a coil 14. A plurality of teeth 13 is formed on an inner peripheral surface of the stator core 12 to be spaced at regular intervals. Slots 13s are formed between the teeth 13 adjacent in a peripheral direction of the stator core 12, respectively, and are spaced on the peripheral direction of the stator core 12 at regular pitches. The coils 14 are arranged on the slots 13s between the teeth 13, respectively.

A rotor 15 composing the electric rotating machine 10 is composed of a rotor core 16 and a plurality of permanent magnets 17 embedded into the rotor core 16. Each of the permanent magnets 17 is formed into a flat plate shape. A plurality of through holes 19 is formed on the rotor core 16. The plurality of through holes 19 is arranged in a peripheral direction of the rotor core 16. A supporting section 18 is formed between the through holes 19 adjacent on the rotor core 16. Each of the through holes 19 pierces the rotor core 16 in its thickness direction. Each of the permanent magnets 17 is housed in each of the through holes 19. Each of the permanent magnets 17 is arranged so that magnetic poles of the adjacent permanent magnets 17 are different from each other. A shaft hole 16h into which an output shaft, not shown, is inserted is formed on a center of the rotor core 16. The rotor 15 rotates together with the output shaft in the shaft hole 16h.

Each of the through hole 19 has a cavity 20 that extends from each of the permanent magnets 17 to an outer edge of the rotor core 16. The cavity 20 is formed between the permanent magnet 17 and the supporting section 18 in the rotor core 16. The cavity 20 functions as a flux barrier. As a result, magnet magnetic flux effectively acts on a torque.

A bridge section 40 is formed between the permanent magnets 17 that are adjacent to each other in the peripheral direction of the rotor core 16 and have different magnetic poles. The bridge section 40 extends between an outer peripheral edge of the rotor core 16 and edges of the through holes 19 in the peripheral direction of the rotor core 16. Each bridge section 40 is formed at a position that is near a corner portion of one of the permanent magnets 17 that is close to the outer peripheral edge of the rotor core 16.

As shown in FIG. 2, the rotor core 16 is constituted so that a plurality of first core plates 21 and a plurality of second core plates 31 are laminated. The first core plate 21 and the second core plate 31 are formed by a steel plate made of a magnetic substance.

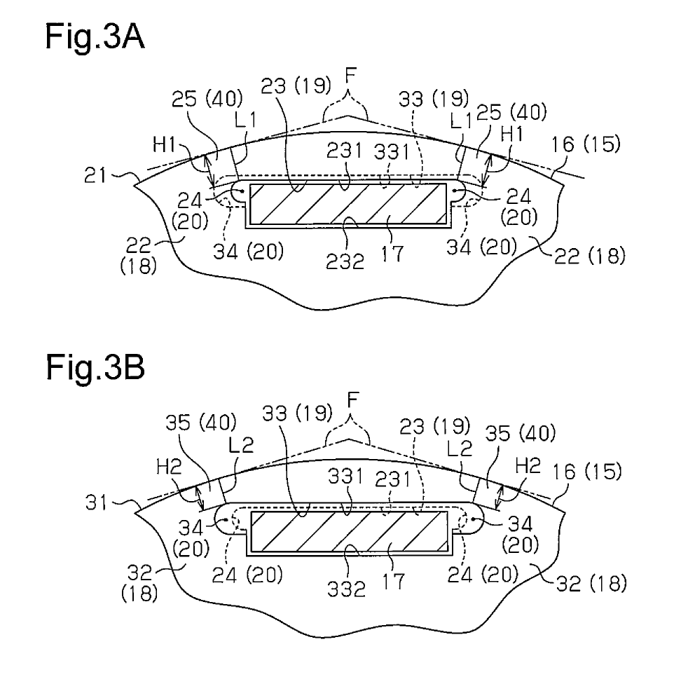

A plurality of first through holes 23 is formed on each of the first core plates 21. The plurality of first through holes 23 is arranged in a peripheral direction of each of the first core plates 21. FIG. 3A illustrates only one first through hole 23. As shown in FIG. 3A, a first supporting section 22 that forms the supporting section 18 is formed between the first through holes 23 adjacent on the first core plate 21. The first through hole 23 has a first cavity 24 forming the cavity 20. The first cavity 24 is formed between the permanent magnet 17 and the first supporting section 22 on the first core plate 21. A first bridge section 25 forming the bridge section 40 is formed on the first core plate 21. The first bridge section 25 extends between an outer peripheral edge of the first core plate 21 and an edge of the first through hole 23 in the peripheral direction of the first core plate 21.

A plurality of second through holes 33 is formed on each of the second core plates 31. The plurality of second through holes 33 is arranged in a peripheral direction of each of the second core plates 31. FIG. 3B illustrates only one second through hole 33. As shown in FIG. 3B, a second supporting section 32 forming the supporting section 18 is formed between the second through holes 33 adjacent on the second core plate 31. The second through hole 33 has a second cavity 34 forming the cavity 20. The second cavity 34 is formed between the permanent magnet 17 and the second supporting section 32 on the second core plate 31. A second bridge section 35 forming the bridge section 40 is formed on the second core plate 31. The second bridge section 35 extends between an outer peripheral edge of the second core plate 31 and an edge of the second through hole 33 in the peripheral direction of the second core plate 31.

As shown in FIG. 3A and FIG. 3B, an outer edge 231 of the first through hole 23 near an outer periphery of the first core plate 21 is closer to the permanent magnet 17 than an outer edge 331 of the second through hole 33 near an outer periphery of the second core plate 31. An inner edge 232 of the first through hole 23 near an inner periphery of the first core plate 21 is arranged to be flush with an inner edge 332 of the second through hole 33 near an inner periphery of the second core plate 31. The outer peripheral edge of the first core plate 21 is positioned to be concyclic with the outer peripheral edge of the second core plate 31.

The second cavity 34 extends to be closer to the outer peripheral edge of the rotor core 16 than the first cavity 24. A minimum distance between the outer peripheral edge of the first core plate 21 and the edge of the first through hole 23 is defined as a first bridge length H1 in the first bridge section 25. Further, a minimum distance between the outer peripheral edge of the second core plate 31 and the edge of the second through hole 33 is defined as a second bridge length H2 in the second bridge section 35. The second bridge length H2 is less than the first bridge length H1. The first bridge length H1 extends to a direction that is orthogonal to a tangent line F of an outer peripheral surface of the first core plate 21. The first bridge length H1 corresponds to a length of a straight line L1 for connecting a portion in the first cavity 24 that is the closest to the outer peripheral edge of the rotor core 16 and the outer peripheral edge of the first core plate 21. The second bridge length H2 extends to a direction orthogonal to a tangent line F of an outer peripheral surface of the second core plate 31. The second bridge length H2 corresponds to a length of a straight line L2 for connecting a portion in the second cavity 34 that is the closest to the outer peripheral edge of the second core plate 31 and the outer peripheral edge of the second core plate 31.

As shown in FIG. 2, the rotor core 16 is formed by laminating the four second core plates 31, the five first core plates 21, the twenty-two second core plates 31, the five first core plates 21, and the four second core plates 31 in this order from left in FIG. 2. Further, the first core plates 21 and the second core plates 31 are laminated so that the outer edges 231 of the first through holes 23 near the outer peripheries of the first core plates 21 are arranged near both ends of the laminating direction of the first core plates 21 and the second core plates 31 on the rotor core 16. Further, a number of the second core plates 31 to be laminated is larger than a number of the first core plates 21 to be laminated. When the plurality of first core plates 21 and the plurality of second core plates 31 are laminated in such a manner, the first through holes 23 are overlapped with the second through holes 33 so that the through holes 19 are formed.

An effect of the electric rotating machine 10 will be described with reference to FIG. 3A and FIG. 3B. As shown in FIG. 3A and FIG. 3B, the second bridge length H2 is less than the first bridge length H1. In this constitution, a region of the bridge section 40 with respect to the entire rotor core 16 is smaller than a case where the first bridge length H1 is equal to the second bridge length H2. For this reason, short-circuit of a magnetic flux across the bridge sections 40 is suppressed.

Further, since the second bridge length H2 is less than the first bridge length H1, strength of the second core plate 31 is lower than strength of the first core plate 21. In this embodiment, the outer edge 231 of the first through holes 23 near the outer periphery of the first core plate 21 is closer to the permanent magnet 17 than the outer edge 331 of the second through hole 33 near the outer periphery of the second core plate 31. For this reason, when the permanent magnet 17 is moved to an outer periphery of the rotor core 16 by a centrifugal force caused by rotation of the rotor core 16, the permanent magnet 17 contacts with the outer edge 231 of the first through holes 23. As a result, a load is not imposed on the second core plate 31 whose strength is lower than that of the first core plate 21 from the permanent magnet 17 by the centrifugal force. That is, the load from the permanent magnet 17 due to the centrifugal force is received by the first core plate 21 whose strength is higher than that of the second core plate 31.

Therefore, in this embodiment, the following effects can be produced.

(1) The outer edge 231 of the first through holes 23 near the outer periphery of the first core plate 21 is closer to the permanent magnet 17 than the outer edge 331 of the second through hole 33 near the outer periphery of the second core plate 31. Further, the second bridge length H2 is less than the first bridge length H1. In this constitution, a region of the bridge section 40 with respect to the entire rotor core 16 is smaller than the case where the first bridge length H1 is equal to the second bridge length H2. For this reason, the short circuit of the magnetic flux across the bridge sections 40 can be suppressed. Further, the load from the permanent magnet 17 due to the centrifugal force is received by the first core plate 21 whose strength is higher than that of the second core plate 31. Therefore, the strength of the outer periphery of the rotor core 16 is secured, and the short circuit of the magnetic flux across the bridge sections 40 can be suppressed.

(2) The first core plates 21 and the second core plates 31 are laminated so that the outer edges 231 of the first through holes 23 near the outer peripheries of the first core plates 21 are arranged near both the ends of the laminating direction of the first core plates 21 and the second core plates 31 in the rotor core 16. In this constitution, the first core plate 21 can receive the load from the permanent magnet 17 caused by the centrifugal force more efficiently than a case where the outer edge 231 of the first through hole 23 is arranged on a center of the laminating direction of the first core plate 21 and the second core plate 31 in the rotor core 16.

(3) The second cavity 34 extends closer to the outer peripheral edge of the rotor core 16 than the first cavity 24. As a result, the second bridge length H2 becomes less than the first bridge length H1. In this constitution, an uneven portion is not formed on the outer peripheral edge of the rotor core 16 differently from a case, for example, where a notch is formed on the outer peripheral edge of the second core plate 31 and the second bridge length H2 is made to be less than the first bridge length H1. Therefore, the uneven portion of the rotor core 16 does not prevent the rotation of the rotor core 16.

(4) The number of the second core plates 31 to be laminated is larger than the number of the first core plates 21 to be laminated. In this constitution, the region of the bridge sections 40 with respect to the entire rotor core 16 is small. For this reason, the short circuit of magnetic flux across the bridge sections 40 is suppressed, and thus a torque is increased.

(5) The plurality of first core plates 21 is sandwiched by the second core plates 31 in the laminating direction of the first core plates 21 and the second core plates 31. For this reason, the plurality of laminated first core plates 21 can be joined to each other by strong force. Therefore, the plurality of first core plates 21 can be provided with enough strength for receiving the loads from the permanent magnets 17 caused by the centrifugal force.

The above embodiment may be modified as follows.

The number of the first core plates 21 and the number of the second core plates 31 to be laminated are not particularly limited. For example, when the number of the first core plates 21 to be laminated is made to be larger than the number of the second core plates 31 to be laminated, the strength for receiving the loads from the permanent magnets 17 caused by the centrifugal force is increased.

The plurality of first core plates 21 does not have to be sandwiched by the second core plates 31 in the laminating direction of the first core plates 21 and the second core plates 31. That is to say, the first core plates 21 may be arranged on both the ends of the laminating direction of the first core plates 21 and the second core plates 31 in the rotor core 16.

The first core plates 21 may be arranged on the center of the laminating direction of the first core plates 21 and the second core plates 31 in the rotor core 16.

A notch may be formed on the outer peripheral edges of the second core plates 31 in order to make the second bridge length H2 less than the first bridge length H1.

Each of the permanent magnets 17 is divided into two to be arranged on the rotor core 16, and a supporting section may be added between the permanent magnets 17 that are divided into two.

1. A permanent magnet embedded type rotor of an electric rotating machine, comprising:
a rotor core having a plurality of through holes arranged in a peripheral direction of the rotor core;
a plurality of permanent magnets housed in the plurality of through holes, respectively, wherein the permanent magnets are arranged so that magnetic poles of adjacent permanent magnets are different from each other; and
bridge sections provided between the permanent magnets that are adjacent in the peripheral direction of the rotor core and that have magnetic poles that are different from each other, wherein each bridge section extends in the peripheral direction of the rotor core between an outer peripheral edge of the rotor core and an edge of one of the through holes, wherein
the rotor core is constituted by laminating a plurality of first core plates and a plurality of second core plates,
each of the first core plates has a first through hole forming the through hole and a first bridge section forming the bridge section,
each of the second core plates has a second through hole forming the through hole and a second bridge section forming the bridge section,
an outer edge of the first through hole near an outer periphery of the first core plate is closer to the permanent magnet than an outer edge of the second through hole near an outer periphery of the second core plate,
a minimum distance between the outer peripheral edge of the first core plate and an edge of the first through hole is defined as a first bridge length in the first bridge section,
a minimum distance between the outer peripheral edge of the second core plate and an edge of the second through hole is defined as a second bridge length in the second bridge section,
the second bridge length is less than the first bridge length.

2. The permanent magnet embedded type rotor of the electric rotating machine according to claim 1,
wherein the first core plates and the second core plates are laminated so that the outer edges of the first through holes near the outer peripheral edges of the first core plates are arranged near both ends of a laminating direction of the first core plates and the second core plates, respectively, in the rotor core.

3. The permanent magnet embedded type rotor of the electric rotating machine according to claim 1,
wherein each of the through holes has a cavity extending from each of the permanent magnets to an outer edge of the rotor core,
each of the first through holes has a first cavity forming the cavity,
each of the second through holes has a second cavity forming the cavity,
the second cavity extends closer to an outer peripheral edge of the rotor core than the first cavity.

4. The permanent magnet embedded type rotor of the electric rotating machine according to claim 1,
wherein a number of the second core plates to be laminated is larger than a number of the first core plates to be laminated.

5. An electric rotating machine comprising the permanent magnet embedded type rotor of claim 1.
